(19) United States
(12) Patent Application Publication
(10) Pub. No.: US 2005/0091318 A1
(43) Pub. Date: Apr. 28, 2005

(54) Enabling a sender to control future recipients of an email

(75) Inventors: Susann Marie Keohane, Austin, TX (US); Gerald Francis McBrearty, Austin, TX (US); Shawn Patrick Mullen, Buda, TX (US); Jessica Murillo, Hutto, TX (US); Johnny Meng-Han Shieh, Austin, TX (US)

Correspondence Address: IBM CORP (AP);C/O AMY PATTILLO, P. O. BOX 161327, AUSTIN, TX, 78716, US

(73) Assignee: International Business Machines Corporation, Armonk, NY (US)

(21) Appl. No.: 10/682,393

(22) Filed: Oct. 9, 2003

(51) Int. Cl. G06F 15/16

(52) U.S. Cl. 709/206

(57) ABSTRACT

A method, system, and program for enabling a sender to control future recipients of an email are provided. An email is received with at least one pre-selected future recipient at a computer system accessible to a primary recipient of the email. The pre-selected future recipient is distinguishable from a sender of an email. The received email is displayed. Then, responsive to the primary recipient electing to respond to the email, a response email is automatically addressed to the at least one pre-selected future recipient, such that a sender of the email controls future recipients of the email by pre-selecting the at least one future recipient. Future recipients may be selected by the sender for each email or automatically selected from a database of addresses each with a pre-selected future recipient based on the primary recipient of the email.

### BACKGROUND OF THE INVENTION

1. Technical Field

The present invention relates in general to improved electronic mail systems and in particular to a method for enabling a sender to control future recipients of an email. Still more particularly, the present invention relates to enabling a sender to pre-select the future recipient addresses of an email if a primary recipient elects to “reply to”, “reply to all” or “forward to” for the email.

2. Description of the Related Art

Networks, and in particular the Internet, provide numerous new methods of communication. A primary use of network communication is in the form of electronic mail (email). In an electronic mail, the sender designates the recipients of the email and sends the email. An email address for the sender is typically included in the email and is automatically the email address registered with the service enabling the email to be sent to the designated recipients. A recipient of an email is typically provided the option by an email reader to reply to the email. Upon requesting to reply to an email, typically a new email window is opened addressed to the sender email address.

Current email services typically utilize email reader software as an interface with the email user. Email users are provided with basic options for composing emails. For example, the sender can select the addresses of recipients of an email. The sender may carbon copy or blind carbon copy some recipients of the email. Additionally, for example, the recipient of an email is typically provided with the options of replying to the sender, replying to the sender and all other recipients, or forwarding the email to new recipients. The basic options provided by email readers to an email user are a good starting point for facilitating email communications. In the area of addressing, however, there is a need for email readers that provide senders more control over addressing in an email.

One problem with email addressing is that one person typically has multiple email accounts provided by different email services. For example, a person may have a work email address where email sent to that address is only accessible from a computer system accessing the work intranet. That same person may have a personal email address where email sent to that address is accessible via an Internet based email service. The person may send an email from the person email address to a work colleague, but the reply address in the email is the person's personal email address. Some email services allow a sender to specify a particular reply address for the sender, however such email services are limited. It would be advantageous to provide a method, system, and program for allowing a sender to pre-select a “reply to” address for emails based on the recipient of the email or the domain name of the recipient address. Further, it would be advantageous to provide a method, system, and program for allowing a sender to send a single email where a different “reply to” address is provided to different recipients of the email.

Another problem with email addressing is that once an email is sent, the sender loses control over who else may view the email. Some email services allow a sender to block a recipient from using the “reply to all” option for an email or from forwarding an email. However, blocking a recipient from sending the email to others does not provide the sender with sufficient flexibility and control over the future recipients of an email. Therefore, it would be advantageous to provide a method, system, and program for allowing the sender to pre-select addresses if the recipient of the email selects the “reply to all” option or the “forward to” option. In particular, to solve both problems with current email addressing, it would be advantageous to provide a method, system and program for enabling a sender to pre-select the future recipient addresses of an email should a recipient of the email elect to reply to or forward the email.

### SUMMARY OF THE INVENTION

In view of the foregoing, it is therefore an object of the present invention to provide improved electronic mail systems.

It is another object of the present invention to provide a method, system and program for enabling a sender to control future recipients of an email.

It is yet another object of the present invention to provide a method, system and program for enabling a sender to pre-select the future recipient addresses of an email if a primary recipient elects to respond to the email.

According to one aspect of the present invention, an email is received with at least one pre-selected future recipient at a computer system accessible to a primary recipient of the email. The pre-selected future recipient is distinguishable from a sender of an email. The received email is displayed. Then, responsive to the primary recipient electing to respond to the email, a response email is automatically addressed to at least one pre-selected future recipient, such that a sender of the email controls future recipients of the email by pre-selecting at least one future recipient.

In one embodiment of the present invention, a primary recipient may elect to respond to the email by selecting a “reply to”, “reply to all”, or “forward to” option. The pre-selected future recipients may be further specified in the email according to which option the primary recipient selects.

When addressing the email to a future recipient, the email may be addressed directly to the future recipient. Alternatively, the email may be carbon copied or blind carbon copied to the future recipient. The actual address for the future recipient may be hidden or displayed. Additionally, the primary recipient may be allowed to select additional recipients of the response email.

According to another aspect of the present invention, future recipients may be selected by the sender for each email or automatically selected from a database of addresses each with a pre-selected future recipient based on the primary recipient of the email. In particular, a sender may designate future recipient addresses in association with primary recipient addresses within the sender's address book. The primary recipient addresses may be individual email addresses or domain names within email addresses.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer system in which the present method, system, and program may be implemented;

FIG. 2 is a block diagram depicting a distributed network system for facilitating pre-selection of email addressing by a sender;

FIG. 3 is a block diagram depicting an email client in accordance with the method, system, and program of the present invention;

FIG. 4 is a block diagram depicting of an address book with pre-selected future recipient addresses in accordance with the method, system, and program of the present invention;

FIG. 5 is a pictorial illustration depicting a composed email with pre-selected future recipients in accordance with the method, system, and program of the present invention;

FIG. 6 is a pictorial illustration depicting a reply to an email where future recipients of the email are pre-selected by the sender in accordance with the method, system, and program of the present invention

FIG. 7 is a pictorial illustration depicting a reply to an email where the “reply to all” future recipients of the email are pre-selected by the sender in accordance with the method, system, and program of the present invention;

FIG. 8 is a high level logic flowchart of a process and program for setting pre-selected future recipients in an email; and

FIG. 9 is a high level logic flowchart of a process and program for automatically designating the recipients of an email based on the future recipients pre-selected by the sender of the email.

### DETAILED DESCRIPTION OF THE PREFERRED EMBODIMENT

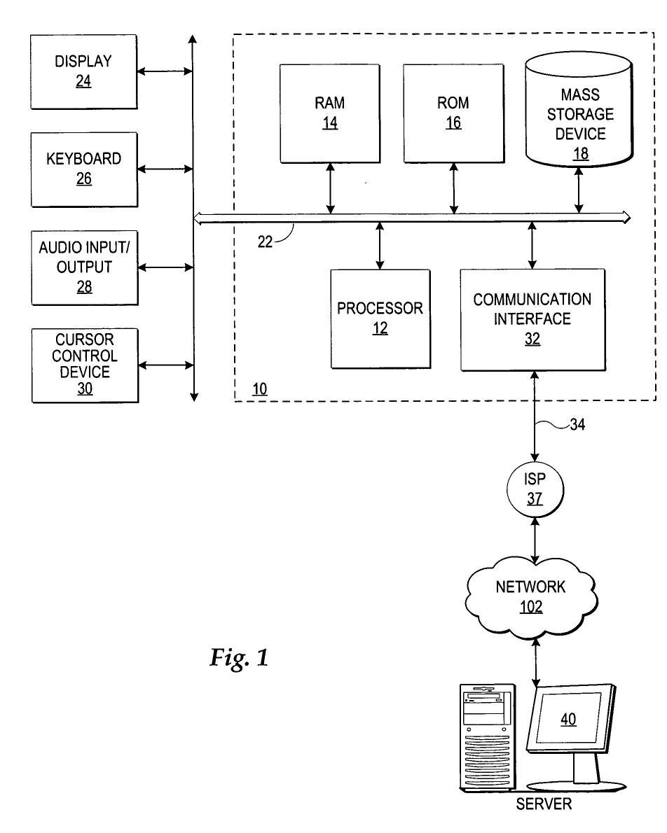

Referring now to the drawings and in particular to FIG. 1, there is depicted one embodiment of a computer system in which the present method, system, and program may be implemented. The present invention may be executed in a variety of systems, including a variety of computing systems and electronic devices under a number of different operating systems. In general, the present invention is executed in a computer system that performs computing tasks such as manipulating data in storage that is accessible to the computer system. In addition, the computer system includes at least one output device and at least one input device.

Computer system 10 includes a bus 22 or other communication device for communicating information within computer system 10, and at least one processing device such as processor 12, coupled to bus 22 for processing information. Bus 22 preferably includes low-latency and higher latency paths that are connected by bridges and adapters and controlled within computer system 10 by multiple bus controllers. When implemented as a server system, computer system 10 typically includes multiple processors designed to improve network servicing power.

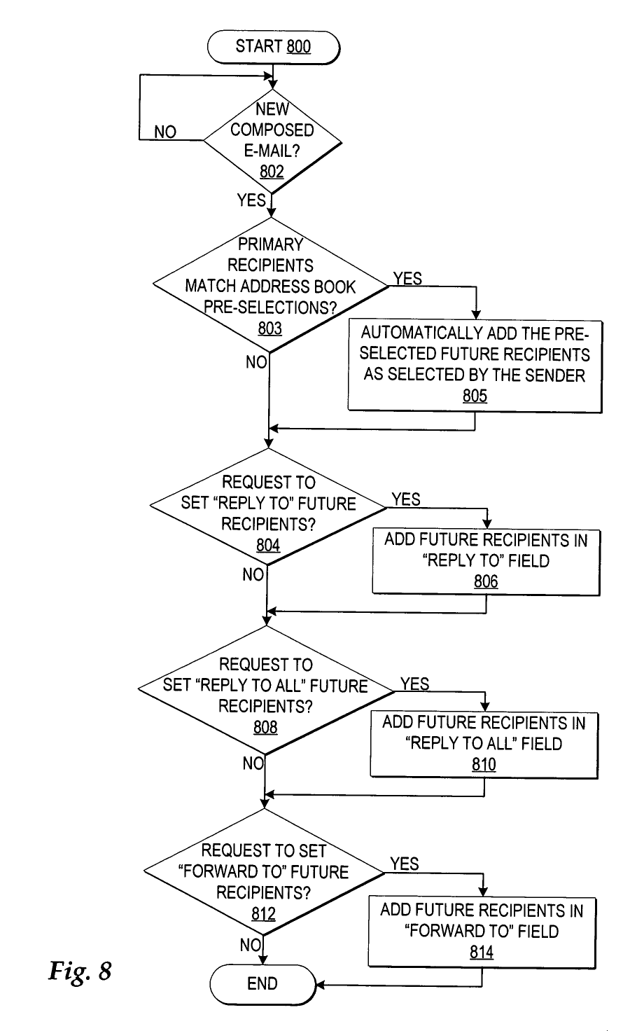

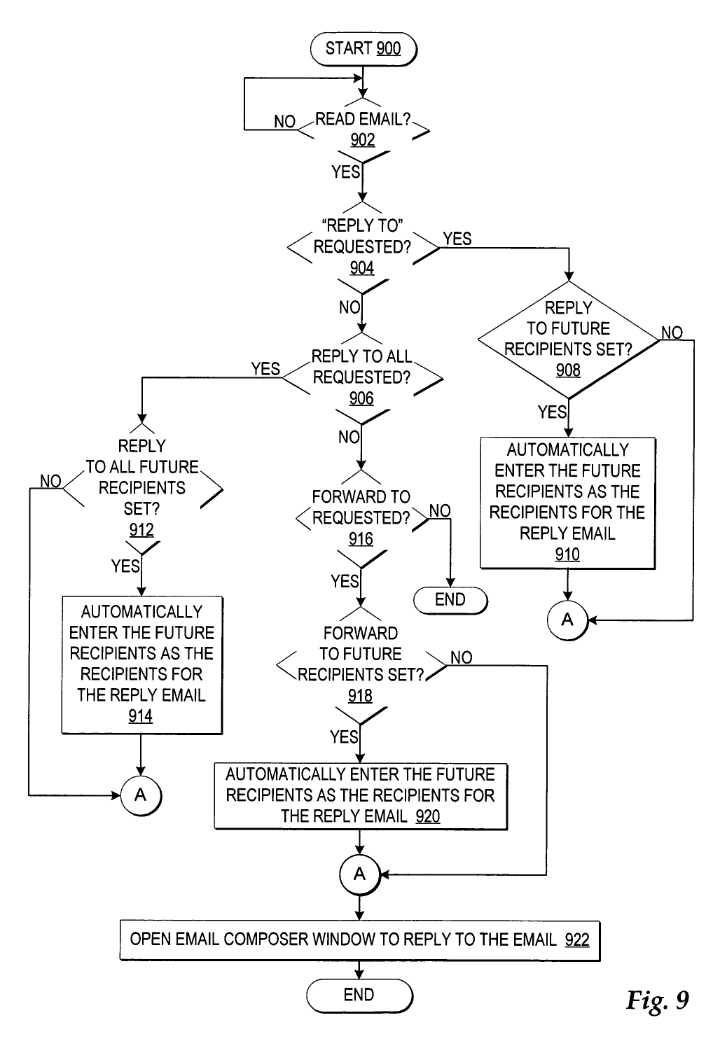

Processor 12 may be a general-purpose processor such as IBM's PowerPC™ processor that, during normal operation, processes data under the control of operating system and application software accessible from a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIGS. 8, 9, and others described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of a non-volatile medium is mass storage device 18 which as depicted is an internal component of computer system 10, but will be understood to also be provided by an external device. Volatile media include dynamic memory such as RAM 14. Transmission media include coaxial cables, copper wire or fiber optics, including the wires that comprise bus 22. Transmission media can also take the form of acoustic or light waves, such as those generated during radio frequency or infrared data communications.

Moreover, the present invention may be downloaded as a computer program product, wherein the program instructions may be transferred from a remote computer such as a server 40 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through network 102. Network 102 may refer to the worldwide collection of networks and gateways that use a particular protocol, such as Transmission Control Protocol (TCP) and Internet Protocol (IP), to communicate with one another. ISP 37 and network 102 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

When implemented as a server system, computer system 10 typically includes multiple communication interfaces accessible via multiple peripheral component interconnect (PCI) bus bridges connected to an input/output controller. In this manner, computer system 10 allows connections to multiple network computers.

Further, multiple peripheral components may be added to computer system 10, connected to multiple controllers, adapters, and expansion slots coupled to one of the multiple levels of bus 22. For example, an audio input/output 28 is connectively enabled on bus 22 for controlling audio input through a microphone or other sound or lip motion capturing device and for controlling audio output through a speaker or other audio projection device. A display 24 is also connectively enabled on bus 22 for providing visual, tactile or other graphical representation formats. A keyboard 26 and cursor control device 30, such as a mouse, trackball, or cursor direction keys, are connectively enabled on bus 22 as interfaces for user inputs to computer system 10. In alternate embodiments of the present invention, additional input and output peripheral components may be added.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

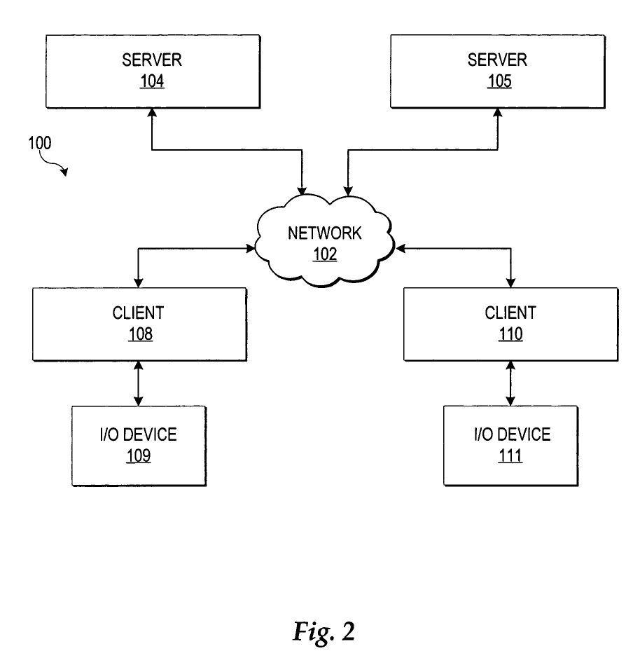

With reference now to FIG. 2, a block diagram depicts a distributed network system for facilitating pre-selection of email addressing by a sender. Distributed data processing system 100 is a network of computers in which the present invention may be implemented. Distributed data processing system 100 contains a network 102, which is the medium used to -provide communications links between various devices and computers connected together within distributed data processing system 100. Network 102 may include permanent connections such as wire or fiber optics cables, temporary connections made through telephone connections and wireless transmission connections.

In the depicted example, mail servers 104 and 105 are connected to network 102. In addition, clients 108 and 110 are connected to network 102 and provide a user interface through input/output (I/O) devices 109 and 111. Mail servers 104 and 105 may contain an electronic mail system from which clients 108 and 110 send and receive email messages through email applications, such as a mail reader, located on clients 108 and 110. Mail readers residing on clients 108 and 110 provide an interface for implementing the mail service on clients 108 and 110. Clients 108 and 110 may be, for example, personal computers or network computers. For purposes of this application, a network computer is any computer coupled to a network, which receives a program or other application from another computer coupled to the network. Distributed data processing system 100 may include additional servers, clients, and other devices not shown. For example, email messages may be sent and received between server 104 and other servers (not shown) to distribute and receive messages from other clients (not shown).

The client/server environment of distributed data processing system 100 is implemented within many network architectures. In one example, distributed data processing system 100 is the Internet with network 102 representing a worldwide collection of networks and gateways that use the TCP/IP suite of protocols to communicate with one another. The Internet is enabled by millions of high-speed data communication lines between major nodes or host computers. In another example, distributed data processing system 100 is implemented as an intranet, a local area network (LAN), or a wide area network (WAN).

Within distributed data processing system 100, each of client systems 108 and 110 and mail servers 104 and 105 may function as both a “client” and a “server” and may be implemented utilizing a computer system such as computer system 10 of FIG. 1. Further, while the present invention is described with emphasis upon mail servers 104 and 105 facilitating the transfer of email, the present invention may also be performed by clients 108 and 110 engaged in peer-to-peer network communications and downloading via network 102.

Multiple layers of protocol are implemented by mail servers 104 and 105 to transfer email to and from clients 108 and 110. First, the text of the message is formatted with a particular protocol. This message format protocol preferably defines the message to have two parts: a header and a body. The message format protocol may use fields or Hypertext Markup Language (HTML) tags that designate addressing information. The header includes fields designating, for example, the sender address, the recipient addresses, and the date and time. For purposes of the present invention, the header fields may also include a reply to address, reply all addresses, and forward to addresses.

Second, the message is transferred in a particular protocol. The typical protocol used for message transfer is the Simply Message Transfer Protocol (SMTP). Messages are transferred between clients 108 and 110 and mail servers 104 and 105 using SMTP running over Transmission Control Protocol (TCP).

Third, the message is read through a mail reader accessible to clients 108 and 110. The user interacts with the mail reader to compose, file, search, read, and reply to email. The mail reader may execute on clients 108 and 110 that access the user's maibox using a protocol such as the Post Office Protocol (POP) or the Internet Message Access Protocol (IMAP). Alternatively, the mail reader may be accessible to clients 104 and 105 from the mail server on which the user's mailbox resides. Further, the mail reader may be an independent application or may be included in a Web browser.

For purposes of the present invention, mail reader preferably pre-selects the “reply to” addresses for a sender based on the recipient or domain name of the recipient address and inserts the “reply to”, “reply to all” and “forward to” address in the header of the email. Additionally, for purposes of the present invention, when a sender pre-selects the “reply to”, “reply to all”, or “forward to” future recipients of an email, the mail reader inserts the future recipient addresses in the header of the email. A mail reader receiving an email with pre-selected “reply to”, “reply to all” or “forward to” addresses, preferably automatically designates the pre-selected address or addresses as the future recipient addresses if the recipient of the email elects one of the “reply to”, “reply to all” or “forward to” options. It will be understood that while the present embodiment is described with emphasis upon the response options of “reply to”, “reply to all”, and “forward to”, the invention may be applied to other response options. Additionally, it will be understood that while the present invention is described with emphasis upon the communication format of electronic mail, the present invention may apply in other communication formats, such as instant messaging, where the future participants in an instant messaging session may be pre-selected by the parties opening the instant messaging session.

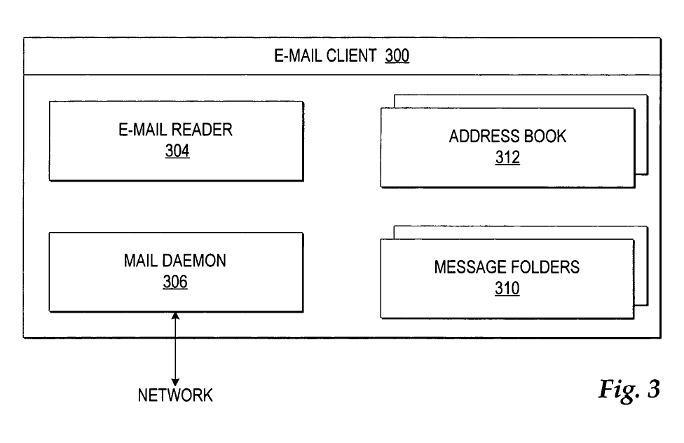

With reference now to FIG. 3, there is depicted a block diagram of an email client in accordance with the method, system, and program of the present invention. As illustrated, an email client 300 includes an email reader 304 and mail daemon 306.

Email reader 304 also allows a user to compose, file, search and read email. Mail daemon 306 receives email intended for the user of email client 300 and stores the email in message folders 310.

Email reader 304 gives mail daemon 306 messages to send to specified intended recipients. Mail daemon 306 may use simple mail transfer protocol (SMTP) running over TCP via the network to transmit the message to a mail daemon running on another machine, typically the mail server, that puts the message into a mailbox where it is retrievable by the intended recipient.

Address book 312 is typically a database for storing email addresses and contact information. For purposes of the present invention, the user preferably designates the “reply to” address preferred by the user for each stored email address. Additionally, the user may designate the “reply to all” and “forward to” addresses preferred by the user for each stored email address. The user may also designate “reply to”, “reply to all” and “forward to” addresses based on domain names of email addresses.

Email reader 304 preferably enables a sender to compose an email. Upon detecting the sender's selection of recipients, email reader 304 designates the “reply to”, “reply to all”, and “forward to” addresses of future recipients of the email based on the sender's pre-selections in address book 312. Additionally, a sender may select the “reply to”, “reply to all”, and “forward to” addresses for an individual email. Upon detecting these selections for an individual email, email reader 304 designates the addresses of future recipients of the email. The addresses of future recipients are designated in fields or HTML flags of the header of the email.

Upon receiving an email, if an intended recipient elects to “reply to”, “reply to all”, or “forward to” the email, then email reader 304 determines whether any future recipients are designated for the election. If future recipients are designated, then email reader 304 automatically inserts the future recipient addresses in the recipient field of the responsive email. The intended recipient composing the responsive email may be allowed to add additional recipients beyond those pre-selected as the future recipients or the intended recipient may be limited to the pre-selections by the sender.

In one embodiment of the present invention, the components described within email client 300 are accessible within a single computer system. However, in alternate embodiments of the present invention, the components described within email client 300 are accessible via multiple computer systems across a distributed network system.

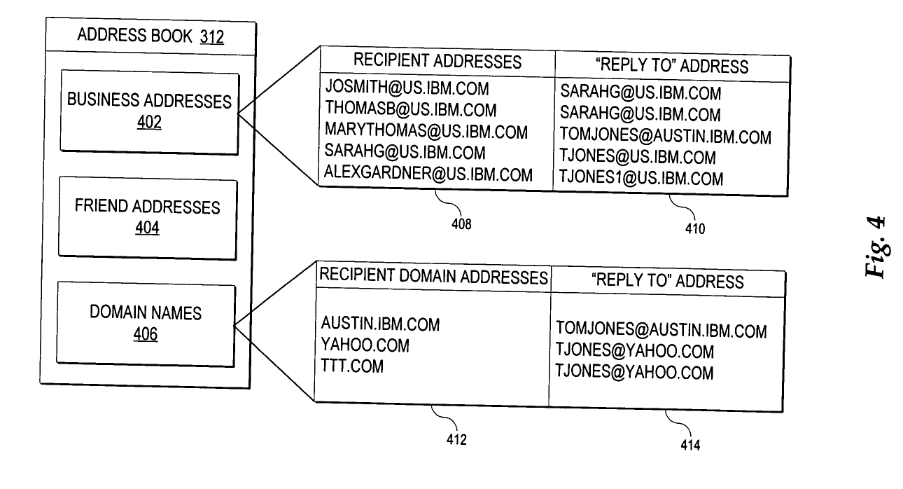

Referring now to FIG. 4, there is illustrated a block diagram of an address book with pre-selected future recipient addresses in accordance with the method, system, and program of the present invention. As depicted, address book 312 of email client 300 in FIG. 3 provides a database of stored email addresses and other addressing information. For purposes of illustration, address book 312 sorts email address in three groups: business addresses 402, friend addresses 404 and domain names 406. It will be understood that any type of database structure may be utilized by address book 312 to sort and store email addresses.

For purposes of example, a selection of the recipient addresses stored in business addresses 402 are depicted at reference numeral 408. For each recipient address, a sender may select the sender address to be used as the “reply to” address dependent upon the recipient address, as depicted at reference numeral 410. As another example, a selection of domain name addresses are stored in domain names 406, as depicted at reference numeral 412. For each domain name in an email address, a sender may select the sender address to be used as the “reply to” address, as depicted at reference numeral 414. Although not depicted in the present examples, in alternate embodiments, in addition to designating a “reply to” address, a sender may designate “reply all” addresses and “forward to” addresses based on the recipient address or domain name address.

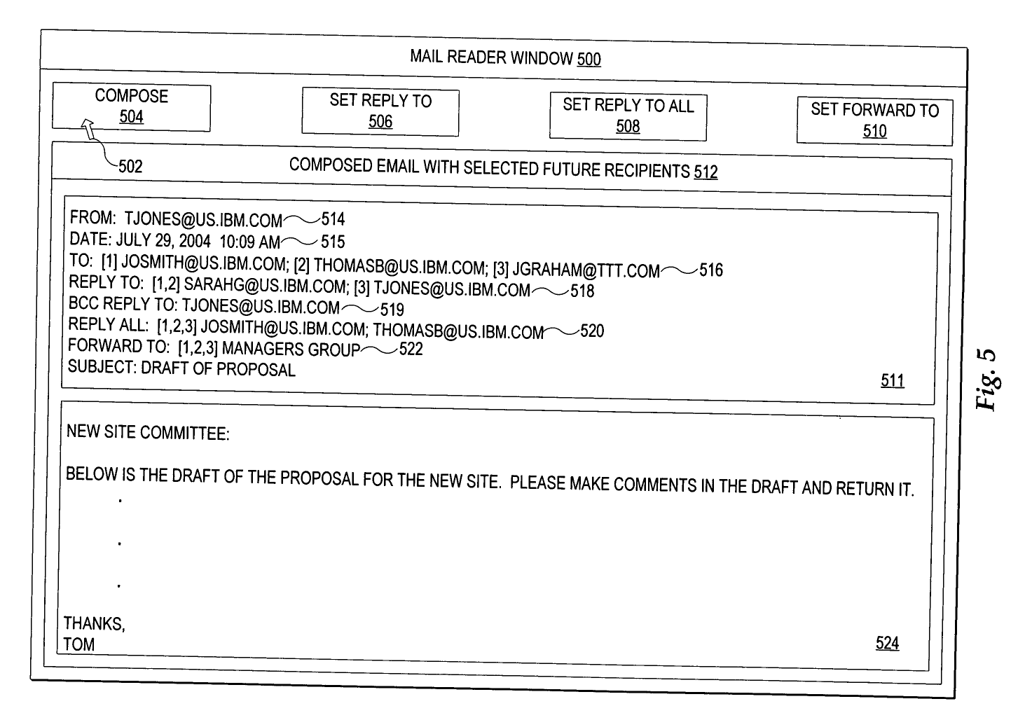

With reference now to FIG. 5, there is depicted a pictorial illustration of a composed email with pre-selected future recipients in accordance with the method, system, and program of the present invention. As illustrated, a mail reader window 500 provides an interface for a user to compose, read, save, and perform other functions with an email. Multiple selectable buttons 504, 506, 508, and 510 are provided within mail reader window 500 for the user to initiate functions of the mail reader by selecting a button with cursor 502. For example, responsive to a user selection of compose button 504, a composed email with selected future recipients 512 is initiated.

In the example, email 512 includes a header 511 and a body 524 of an email. In header 511, multiple fields are illustrated. It will be understood that although the present invention is described with reference to an email with a header and body, other types of messaging protocols may be used.

First, a “from” field 514 designates the email address of the sender of the email. Next, a date field 515 designates the date and time the email was sent. Thereafter, a recipient field 516 indicates the recipient addresses of the current email. For purposes of illustration, each address is assigned a numerical identifier.

Next, a “reply to” field 518 designates the future recipients of the email if the “reply to” option is selected by a recipient of email 512. In the example, the “reply to” addresses are automatically entered based on the sender's selections in the address book depicted in FIG. 4. In an alternate embodiment, the sender may also select the set “reply to” button 506 and then select a “reply to” address.

Additionally, a “BCC reply to” field 519 designates the future recipients of the email if the “reply to” option is selected by a recipient of email 512. The “BCC reply to” is a blind carbon copy of an email when a recipient select to reply to the email.

A “reply to all” field 520 designates the future recipients of the email if the “reply to all” option is selected by a recipient of email 512. In the example, the “reply to all” addresses are selected by the sender specifically for email 512 by selecting the set “reply to all” button 508 and then selecting specific adresses. In an alternate embodiment, the “reply to all” addresses may be automatically entered based on pre-selections made in the sender address book.

A “forward to” field 522 designates the future recipients of the email if the “forward to” option is selected by a recipient of email 512. In the example, the “forward to” recipient list is a group name that represents multiple email addresses. The sender selected the “forward to” recipients by selecting the set “forward to” button 510 and selecting the recipient group. In an alternate embodiment, the “forward to” address may be automatically entered based on pre-selections made in the sender address book.

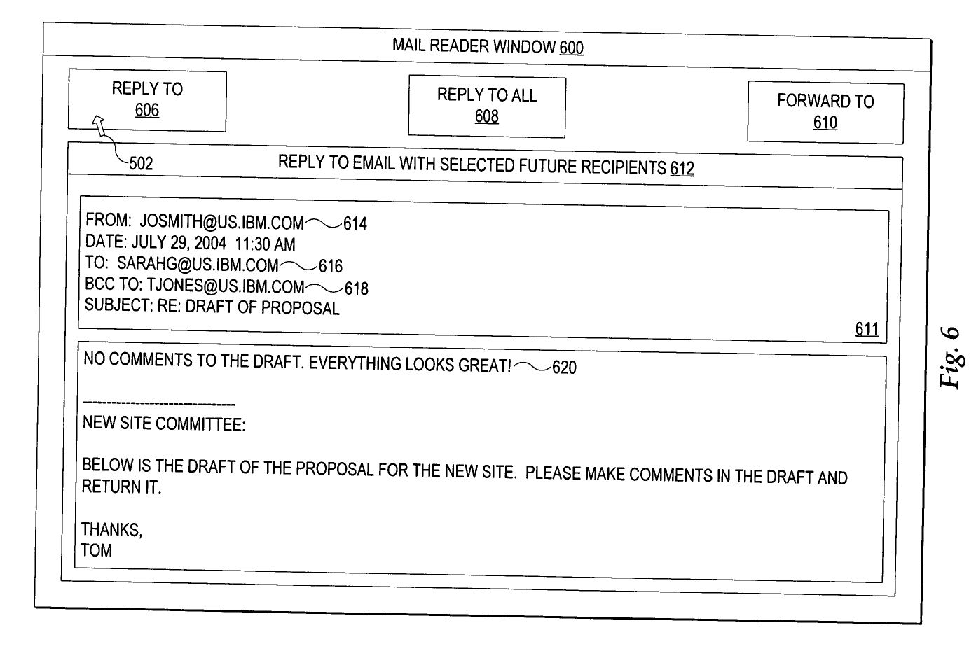

Referring now to FIG. 6, there is depicted a pictorial illustration of a reply to an email where future recipients of the email are pre-selected by the sender in accordance with the method, system, and program of the present invention. As illustrated, mail reader window 600 enables the display of a “reply to” email with selected future recipients 612. Mail reader window 600 includes multiple selectable buttons 606, 608, and 610 for a recipient reading an email to select with cursor 502. In this example, the recipient josmith@us.ibm.com selects “reply to” button 606. In response, the mail reader composes email 612.

In email 612, the previous text of the email is displayed and the recipient adds additional text, as indicated at reference numeral 620. In header 611, the address in “from” field 614 is automatically selected as the recipient email address. The recipient of an email may also set a “reply to” address different from the “from” address.

In email 612, the email reader automatically selects the recipient in “to” field 616 as the future recipient selected by the sender if a “reply to” option is selected. The recipient may also be allowed to add additional recipient addresses or may be barred completely from -choosing recipients other than the future recipients pre-selected by the sender of the email.

Additionally, in email 612, the email reader automatically selects the recipient in “BCC to” field 618. Advantageously, the blind carbon copy address may be hidden from the replier's view or may be displayed.

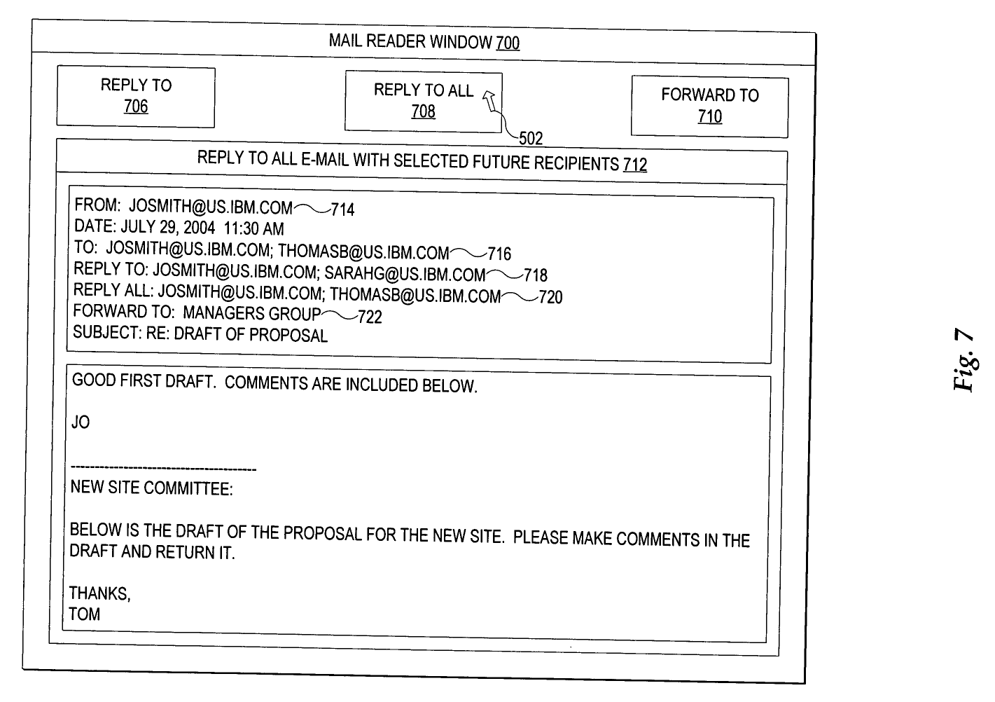

With reference now to FIG. 7, there is illustrated a pictorial illustration of a reply to an email where the “reply to all” future recipients of the email are pre-selected by the sender in accordance with the method, system, and program of the present invention. As depicted, mail reader window 700 enables the display of a “reply to all” email with selected future recipients 712. Mail reader window 700 includes multiple selectable buttons 706, 708, and 710 for a recipient reading an email to select with cursor 502. In this example, the recipient selects “reply to all” button 708. In response, the mail reader composes email 712.

In header 711, the address in “from” field 714 is automatically selected as the recipient address. In addition, in header 711, the email reader automatically selects the addresses in recipient field 716 according to the “reply to all” future recipients designated by the sender.

In this example, the addresses in “reply to” field 718, “reply to all” field 720, and “forward to” field 722 are maintained from the sender pre-selections. Additionally, the primary recipient now sending email 712 has added the recipient's address in “reply to” field 718.

Referring now to FIG. 8, there is depicted a high level logic flowchart of a process and program for setting pre-selected future recipients in an email. As illustrated, the process starts at block 800 and thereafter proceeds to block 802. Block 802 depicts a determination whether a new composed e-mail is detected. The process iterates at block 802 until a new composed e-mail is detected, then the process passes to block 803. A new composed e-mail may include an email composed as a result of selecting to compose mail and may include an email composed as a result of selecting to reply to or forward an email.

Block 803 depicts a determination whether the primary recipients of the email match address book pre-selections. If the primary recipients do not match address book pre-selections, then the process passes to block 804. If the primary recipients match address book pre-selections, then the process passes to block 805. Block 805 depicts automatically adding the pre-selected future recipients as designated by the sender in the address book, and the process passes to block 804.

Block 804 illustrates a determination whether the sender requests to set the “reply to” future recipients. If the sender does not request to set the “reply to” future recipients, then the process passes to block 808. If the sender does request to set the “reply to” future recipients, then the process passes to block 806. Block 806 depicts adding the future recipients in the “reply to” field, and the process passes to block 808.

Block 808 depicts a determination whether the sender requests to set the “reply to all” future recipients. If the sender does not request to set the “reply to all” future recipients, then the process passes to block 812. If the sender does request to set the “reply to all” future recipients, then the process passes to block 810. Block 816 depicts adding the future recipients in the “reply to all” field, and the process passes to block 812.

Block 812 depicts a determination whether the sender requests to set the “forward to” future recipients. If the sender does not request to set the “forward to” future recipients, then the process ends. If the sender does request to set the “forward to” future recipients, then the process passes to block 814. Block 814 depicts adding the future recipients in the “forward to” field, and the process ends. While in the present embodiment the process allows specification of future recipients for “reply to”, “reply to all”, and “forward to” option, it will be understood that in alternate processes future recipients may be set for other options in an email.

With reference now to FIG. 9, there is depicted a high level logic flowchart of a process and program for automatically designating the recipients of an email based on the future recipients pre-selected by the sender of the email. As illustrated, the process starts at block 900 and thereafter proceeds to block 902. Block 902 depicts a determination whether an email is read by a recipient. The process iterates at block 902 until an email is read, then the process passes to block 904. Block 904 depicts a determination of whether a “reply to” is requested. If a “reply to” is not requested, then the process passes to block 906. If a “reply to” is requested, then the process passes to block 908. Block 908 depicts a determination whether there are “reply to” future recipients set in the email. If there are not “reply to” future recipients set, then the process passes to block 922, described later in the process. If there are “reply to” future recipients set, then the process passes to block 910. Block 910 depicts automatically entering the future recipients as the only recipients for the email, and the process passes to block 922. In alternate embodiments, the recipient may choose to “reply to” and to “forward to” for the same email.

Block 906 depicts a determination of whether a “reply to all” is requested. If a “reply to all” is not requested, then the process passes to block 916. If a “reply to all” is requested, then the process passes to block 912. Block 912 depicts a determination whether there are “reply to all” future recipients set in the email. If there are not “reply to all” future recipients set, then the process passes to block 922, described later in the process. If there are “reply to all” future recipients set, then the process passes to block 914. Block 914 depicts automatically entering the future recipients as the only recipients for the email, and the process passes to block 922.

Block 916 depicts a determination of whether a “forward to” is requested. If a “forward to” is not requested, then the process ends. If a “forward to” is requested, then the process passes to block 918. Block 918 depicts a determination whether there are “forward to” future recipients set in the email. If there are not “forward to” future recipients set, then the process passes to block 922, described later in the process. If there are “forward to” future recipients set, then the process passes to block 920. Block 920 depicts automatically entering the future recipients as the only recipients for the email, and the process passes to block 922.

Block 922 depicts opening and email composer window to reply to the email, and the process ends. If the email composer window, the header of the email displays any automatically selected recipients. Additionally, the replier may be enabled to specify future recipients for the reply email and a reply to address for the replier may be automatically selected based on pre-selections by the replier for the future recipients.

While the invention has been particularly shown and described with reference to a preferred embodiment, it will be understood by those skilled in the art that various changes in form and detail may be made therein without departing from the spirit and scope of the invention.

1. A method for controlling future recipients of an email, comprising:
receiving an email with at least one pre-selected future recipient at a computer system accessible to a primary recipient of said email, wherein said at least one pre-selected future recipient is distinguishable from a sender of said email;
displaying said received email; and
responsive to said primary recipient electing to respond to said email, automatically addressing a response email to said at least one pre-selected future recipient, such that a sender of said email controls future recipients of said email by pre-selecting said at least one fixture recipient.

2. The method of claim 1 for controlling future recipients of an email, further comprising:
receiving an election to respond by replying to said email.

3. The method of claim 1 for controlling future recipients of an email, further comprising:
receiving an election to respond by forwarding said email.

4. The method of claim 1 for controlling future recipients of an email, further comprising:
automatically addressing said response email as a carbon copy to said at least one pre-selected future recipient.

5. The method of claim 1 for controlling future recipients of an email, further comprising:
hiding an actual address for said at least one pre-selected future recipient.

6. The method of claim 1 for controlling future recipients of an email, further comprising:
enabling said primary recipient to select additional recipients of said response email.

7. An electronic mail system, comprising:
a computer system communicatively connected to a network;
means for receiving an email with at least one pre-selected future recipient at said computer system accessible to a primary recipient of said email;
means for displaying said received email; and
means responsive to said primary recipient electing to respond to said email, for automatically addressing a response email to said at least one pre-selected future recipient.

8. The electronic mail system of claim 7, further comprising:
means for receiving an election to respond by replying to said email.

9. The electronic mail system of claim 7, further comprising:
means for receiving an election to respond by forwarding said email.

10. The electronic mail system of claim 7, further comprising:
means for automatically addressing said response email as a carbon copy to said at least one pre-selected future recipient.

11. The electronic mail system of claim 7, further comprising:
means for hiding an actual address for said at least one pre-selected future recipient.

12. The electronic mail system of claim 7, further comprising:
means for enabling said primary recipient to select additional recipients of said response email.

13. A computer program product for controlling future recipients of an email, comprising:
a recording medium;
means, recorded on said recording medium, for accessing an email intended for a primary recipient with at least one pre-selected future recipient specified by a sender of said email, wherein said at least one pre-selected future recipient is distinguishable from said sender of said email;
means, recorded on said recording medium, for displaying said received email; and
means, recorded on said recording medium, for automatically addressing a response email to said at least one pre-selected future recipient, responsive to said primary recipient electing to respond to said email.

14. The computer program product of claim 13 for controlling future recipients of an email, further comprising:
means, recorded on said recording medium, for receiving an election to respond by replying to said email.

15. The computer program product of claim 13 for controlling future recipients of an email, further comprising:
means, recorded on said recording medium, for receiving an election to respond by forwarding said email.

16. The computer program product of claim 13 for controlling future recipients of an email, further comprising:
means, recorded on said recording medium, for automatically addressing said response email as a carbon copy to said at least one pre-selected future recipient.

17. The computer program product of claim 13 for controlling future recipients of an email, further comprising:
means, recorded on said recording medium, for hiding an actual address for said at least one pre-selected future recipient.

18. The computer program product of claim 13 for controlling future recipients of an email, further comprising:
means, recorded on said recording medium, for enabling said primary recipient to select additional recipients of said response email.

19. A method for enabling a sender to control future recipients of an email, comprising:
responsive to a request to compose a new email, enabling a sender of said email to designate at least one future recipient of said email; and
embedding said at least one future recipient in a header of said email, wherein a mail reader receiving said email is directed to address any response to said email to said at least one future recipient.

20. A method for pre-selecting future recipients of an email, comprising:
detecting a composed email with at least one primary recipient;
comparing said at least one primary recipient with an plurality of addresses each specified with a pre-selected future recipient; and
responsive to said at least one primary recipient matching one of said plurality of addresses, automatically designating said matching pre-selected future recipients for said address in said email.
